(19) United States
(12) Patent Application Publication
(10) Pub. No.: US 2015/0097104 A1
(43) Pub. Date: Apr. 9, 2015

(54) NONSTICK TREATMENT FOR COMPOSITE MOLDS

(71) Applicant: ASSOCIATION POUR LES TRANSFERTS DE TECHNOLOGIES DU MANS, Le Mans (FR)

(72) Inventors: Roxane Noblat, Le Mans (FR); Bruno Lator, Quimperle (FR)

(73) Assignee: Association pour les Transferts de Technologies du Mans, Le Mans (FR)

(21) Appl. No.: 14/381,397

(22) PCT Filed: Feb. 22, 2013
(86) PCT No.: PCT/EP2013/053602

§ 371 Date: Aug. 27, 2014

(30) Foreign Application Priority Data
Feb. 29, 2012 (FR) 1251869

(51) Int. Cl. B29C 33/58; B29C 33/38; B29C 33/62

(52) U.S. Cl. CPC B29C 33/58; B29C 33/62; B29C 33/38; B29K 2863/00; B29K 2827/12; B29K 2995/0012
USPC 249/115; 427/133

(57) ABSTRACT

A method for rendering nonstick a mold made of composite material, including the steps of: (i) providing a mold made of a composite material including an epoxy resin; (ii) applying a fluorinated-polymer powder, having a minimum film-forming temperature of less than 300° C. and heat resistance at temperatures higher than 200° C., onto the walls of the mold so as to form a layer; and (iii) heating the resulting layer to a temperature of between 260° C. and 300° C. so as to form a continuous film, whereby a mold made of a composite material is obtained the walls of which are provided with a nonstick coating. The present disclosure also relates to the mold obtainable by said method.

The present invention relates to a method for treating molds made of composite material to obtain a nonstick surface to facilitate mold release, and the molds thus obtained.

### STATE OF THE ART

The increasing demand for large parts made of composite material, in particular for aeronautic applications, has contributed to the use of tooling in lighter composite material to the detriment of metal tooling. In particular the use of molds in composite material will tend to become more widespread.

There are numerous existing technologies to obtain nonstick metal molds to facilitate the release of the molded part.

It is known to coat the mold surfaces with a mold release agent e.g. a silicon compound as described for example in patent application FR 2846591. These coatings are not long-lasting however and as a result, the treatment must be repeated at regular intervals.

It is also known to obtain a nonstick mold surface by coating with polytetrafluoroethylene (PTFE). Said coating can be obtained by depositing PTFE in powder form followed by heat treatment at sufficient temperature to allow coalescence of the powder particles into a continuous film. For PTFE this film-forming temperature is about 360° C. However, most composite molds cannot withstand a temperature higher than 300° C.

### SUMMARY OF THE INVENTION

It is therefore the objective of the invention to propose a method for improving easy release from composite molds containing resins such as epoxy resins, which can be conducted at a temperature compatible with their heat resistance.

A further objective is to propose such molds provided with a durable nonstick coating.

The above objectives are reached according to the invention by depositing on the surface of composite molds a thin film of fluorinated polymer, in particular a copolymer of fluoroethylene and fluoropropylene (FEP) as mold release agent.

Indeed, it has been found that it is possible to form a film of this polymer at a temperature compatible with composite molds since its film-forming temperature is in the region of 260° C.

Advantageously, this polymer is also non-toxic, inert vis-à-vis the mold, adapts to molds of complex geometry and is compatible with most resins used in composite materials.

Therefore, according to a first aspect, the invention concerns a method to obtain a nonstick mold made of composite material, comprising the steps of:

(i) providing a mold made of composite material comprising an epoxy resin;

(ii) applying a powder of fluorinated polymer having a minimum film-forming temperature lower than 300° C. and heat resistance higher than 200° C., onto the walls of the mold to form a layer; and

(iii) heating the layer obtained at a temperature of between 260° C. and 300° C. to form a continuous film;

whereby a mold made of composite material is obtained whose walls are provided with a nonstick coating.

Preferably the mold made of composite material comprises carbon fibers.

According to one preferred embodiment, the fluorinated polymer is a polymer or copolymer of fluoroalkylene, in particular fluoroethylene. Among these polymers the copolymer of fluoroethylene and propylene has proved to be of particular interest. Particular preference is given to a copolymer of perfluoroethylene and perfluoropropylene (FEP).

The fluorinated polymer in powder form can be applied in dispersion form, an aqueous dispersion in particular.

According to one embodiment of the invention, step (iii) is performed in an oven. Alternatively step (iii) can be performed using infrared radiation.

Preferably the coating obtained from the layer of fluorinated polymer has a thickness of between 10 and 100 μm.

According to a second aspect, the invention concerns a mold in composite material obtainable using the method of the invention, intended in particular for the manufacture of parts made of composite material.

### DEFINITIONS

In the present description, by the term [symbol] copolymer [symbol] it is meant to designate a polymer derived from copolymerization of at least two types of monomers that are chemically different. It is therefore formed of at least two repeating units. The repeating units may be contained in the copolymer so as to form random, alternating, statistical or block arrangements. The first three arrangements lead to a homogenous copolymer, whereas block copolymers exist which are heterogeneous and may be block or graft copolymers. Heterogeneous copolymers are characterized by a microstructure having several phases and glass transition temperatures Tg.

By the term [symbol] composite material [symbol] it is meant to designate a material resulting from the assembling of at least two non-miscible materials having a certain affinity. The resulting new material has properties that the elements alone do not have. Most often the composite material comprises a matrix formed by a continuous phase, and a reinforcement forming a discontinuous phase in the matrix. The matrix may in particular be a thermoplastic or thermosetting resin. It ensures the cohesion of the structure and the re-transmitting of forces towards the reinforcement. The reinforcement forms a backbone ensuring the mechanical strength and protection of the matrix. The reinforcement may notably be in the form of fibers; these fibers can be assembled into sheets of continuous fabric called plies. The composite material may in particular be formed by the stacking of 1 to 10 such plies within the matrix.

By the term [symbol] fluoroalkylene [symbol] and more specifically [symbol] fluoroethylene [symbol] and [symbol] fluoropropylene [symbol] , it is generally meant to designate ethylene wherein one, two, three or four hydrogen atoms are replaced by a fluorine atom.

By the term [symbol] minimum film-forming temperature [symbol] (MFT) it is meant to designate the temperature at which a powder material forms a continuous film via coalescence of the droplets formed by melting of the particles.

### DETAILED DESCRIPTION OF THE INVENTION

With the method of the invention it is possible to rapidly and easily to prepare molds provided with a robust, durable non-stick coating, even if the heat resistance of the molds does not exceed 300° C.

The method is performed by depositing a fluorine polymer on the surface of the mold, in particular a copolymer of fluoroethylene and fluoropropylene (FEP), in powder form, followed by a heating step to complete the homogeneity and continuous nature of the deposited film.

The mold in composite material is in an organic matrix composite material (OMC) comprising an epoxy resin (EP). Other resins such as unsaturated polyester resins (UPs), vinylester resins, phenolic resins (PF) and thermosetting polyimide resins (PIRPs), or thermoplastics such as polypropylene or polyamide, or polyether imide (PEI), polyphenylene sulfide (PPS) and polyetheretherketone (PEEK) can optionally be used.

The reinforcements contained in the composite material may in theory be any reinforcement. They are generally classified according to their composition, their shape (short fibers (0.1-1 mm), long fibers (1-50 mm) or continuous fibers (>50 mm)) and their arrangement (parallel, angled or random, matted or woven). The composite material may comprise a single or several different reinforcements. Among the fibers mention can be made of glass fibers, carbon fibers, aramid fibers, silicon carbide fibers and plant fibers such as hemp or flax.

The molds in composite material with reinforcements in carbon fibers and an epoxy resin as matrix are particularly preferred.

Advantageously, the method of the invention can implemented with molds of any shape and size.

The copolymer of fluoroethylene and fluoropropylene (FEP) used as mold release agent is a copolymer of hexafluoropropylene and tetrafluoroethylene. It is sold in particular by Dupont under the trade name Teflon® FEP, by Daikin under the trade name Neoflon® and by Dyneon/3M under the trade name Dyneon® FEP.

Preferably the copolymer is used when already polymerized. This copolymer is scarcely soluble and is therefore generally offered in dispersion in a solvent or in water. However it may also be in microparticle form.

For practical reasons, preferably an aqueous dispersion is chosen. Such FEP formulations are commercially available e.g. under the trade name Xylan® 80-650 sold by Whitford France, Pontault-Combault or Teflon® FEP TE-9568 sold by Dupont.

In general, it is not necessary to apply a primer to the surface. However if it is so desired a product of PRIMER 420-710 type sold by Dupont can be used which is a mixture of synthetic resins and solvents containing N-methyl-2-pyrrolidone.

The fluorinated polymer, most often in dispersion form, can be applied to the walls of the mold to be coated using means generally used for this purpose e.g. by dipping or spraying, gun spraying in particular. Gun spraying is preferred since it ensures the easy obtaining of a thin homogeneous film even with molds of complex geometry, and does not require the providing of bath equipment.

Preferably, several layers are applied e.g. 2, 3 or even 4 layers to ensure complete coverage of the surface and to obtain a durable, resistant coating.

Each layer, in the dry state, preferably has a thickness of 20 to 30 μm.

The final thickness of the coating of dry fluorinated polymer is advantageously between 10 and 150, preferably between 20 and 130 μm. On account of its low thickness, the coating does not generally affect the dimensions of the part to be molded.

After the coating has been dried, optionally under ventilation, heat treatment is carried out to form a homogeneous, continuous film. Heat treatment is performed so as to reach the film-forming temperature of the fluorinated polymer, also called minimum film-forming temperature which for FEP generally lies between 260° C. and 300° C. Heating can be carried out using any known means for this purpose e.g. in a kiln or oven or, advantageously for large-size molds, via the local applying of an infrared lamp or other means allowing local, external heating of the mold such as a heating resistance or hot air. It is also possible to make provision so that the mold is self-heating being provided with its own heating means. In this case several heating means are possible; for example the mold can be equipped with heating electric wires or channels for heat-exchange fluid, or with means to blow hot air onto the composite mold.

Preferably the heat treatment step is chosen so as to avoid lengthy exposure of the mold in composite material to high temperatures. For example, the heat treatment advantageously does not exceed 30 minutes at a temperature above 260° C., and preferably does not exceed 15 minutes at a temperature above 280° C.

After heat treatment, the coated molds are ready to use.

The molds obtainable with the method of the invention are characterized by excellent ease of mold release. The low transfer coefficient of fluorinated polymers generally ensures easy mold release for at least 20 cycles. The coated molds can be used in the usual manner.

The coated molds thus obtained are particularly suitable for the manufacture of parts made of composite material. They can be used for any of the processes used such as resin transfer molding RTM, liquid resin infusion (LRI), liquid resin infusion—vacuum assisted processing (LRI-VAP) or the resin film infusion process (RFI).

The method of the invention therefore provides rapid, easy means for obtaining non-stick molds made of composite material. In addition it can be adapted to molds of complex geometry and can be given large-scale application. Also, the coating obtained has good resistance to surrounding conditions and temperature cycles to which a mold is subjected. Finally the coating can advantageously be repaired by heating if it has been locally pierced, if necessary with filler material.

The invention is better explained in connection with the following non-limiting examples.

### EXAMPLES

### Example 1

Coating a composite mold with a thin layer of FEP, calibrated bar coating. On the clean, dry inner surfaces of a mold made of carbon fiber/epoxy composite having a size of 60×60 mm, two thin layers of a dispersion of fluoroethylene and fluoropropylene copolymer (FEP) (Xylan® 80-650 sold by Whitford France, Pontault-Combault) were applied using a calibrated bar allowing control over the deposited wet thickness.

This thickness is chosen taking into account the dry extract of the dispersion. Here the bar used was a 100 μm bar, giving a dry layer after desolvation of 30 μm. The final dry film composed of two layers therefore had a thickness of 60 μm.

In general, to form a continuous FEP film, heat treatment is carried out allowing coalescence of the deposited particles, by heating the FEP up to 265° C. with a temperature hold of a few minutes at this temperature.

If bar coating is used, each intermediate layer must undergo desolvation and film-forming heat treatment before applying the following layer thereupon.

During heat treatment of the last layer the different layers re-melt and homogenize together.

The coating thus obtained successfully passed the cross-cut test as per standard ISO 2409 for adhesion to the composite mold. It also had very low surface energy in the region of 15-16 mJ/m², a property that is required for a nonstick coating. This surface energy was measured following the ASTM 7490-08 standard using 2 liquids in accordance with the Owens-Wendt model.

Molding and mold release tests were performed on the mold thus coated.

The glued pad test entails polymerizing a pad of epoxy resin on the surface of the FEP-coated carbon/epoxy mold. After curing it was found that there was no adhesion of the epoxy pad on the mold with epoxy matrix. By merely tilting the plate the pad was seen to slide. The result was better than with a conventional non-durable mold release agent

The tests were repeated on the surfaces as such, at the same points. A minimum number of about ten mold releases can be carried out without observing any adhesion.

The results obtained show that the application of a FEP copolymer as mold release agent allows nonstick coatings to be obtained on composite molds without the need for high temperature heat treatment.

### Example 2

Coating of a composite mold with a thin FEP layer, application by gun spraying

In this example, on the clean, dry inner surfaces of a mold made of carbon fiber/epoxy composite having a size of 120×150 mm, two thin layers of a dispersion of fluoroethylene and propylene copolymer (FEP) (Xylan® 80-650 sold by Whitford France, Pontault-Combault) were applied using a KREMLIN paint gun operated by compressed air and set at a rate of 30 μm/sec. Here, only one desolvation was carried out between the two layers. After the second layer the coating was again desolvated.

The final thickness of the coating obtained on the mold was lower than 100 μm.

Heat treatment was then conducted allowing coalescence of the deposited particles, by placing the mold in an oven regulated at a temperature rise up to 265° C. followed by a temperature hold for a few minutes at this temperature (5 to 10 minutes).

The coating obtained successfully passed the cross-cut test as per standard ISO 2409 for adhesion to the composite mold. It also had very low surface energy, in the region of 15-16 mJ/m², a property required for a nonstick coating. This surface energy was measured following standard ASTM 7490-08 with 2 liquids and using the Owens-Wendt model.

Molding-mold release tests were conducted on the coated mold.

These used a carbon fabric pre-impregnated with epoxy resin, called a prepreg and used in industry. The prepreg was polymerized under load on the mold to simulate the RFI process. After curing at 180° C. as stipulated for this material, on merely removing the weight the prepreg was lifted without any adhesion.

The tests were repeated on the surfaces as such at the same points. A minimum number of about ten mold release operations can be carried out without observing any adhesion.

The results obtained show that the application of FEP copolymer as mold release agent allows nonstick coatings to be obtained on composite molds without the need for high temperature treatment.

### Example 3

Heat treatment via infrared radiation

After depositing the FEP as in Example 1, film-forming heat tests of FEP were conducted using an epiradiator and infrared radiation.

An epiradiator is formed of a 500 W heating resistance placed behind a silica disc (quartz) 100 mm in diameter. It releases infrared energy providing radiation heat. In our case it was placed at a distance chosen to obtain a temperature of 260-270° C. on the surface of the composite (prior calibration on uncoated composite). Temperature was recorded by a remote infrared thermometer.

This heating mode allows surface heating and avoids having to place the entire mold at 265° C. The surface temperature of 265° C. was maintained for 5 to 10 minutes, the time needed for formation of the film.

The adhesion of the FEP layer to the support was the same as with heat treatment in an oven, namely the coating obtained successfully passed the cross-cut test of standard ISO 2409 for adhesion to the composite mold.

### Example 4

Capability of Repair

Local wear of the surface, deliberately produced using a knife, was touched up with fluorinated polymer using a brush.

The repaired area was locally heated using an epiradiator as described in Example 3 above.

The coating thus repaired was found to be continuous and produced satisfactory results in terms of nonstick properties.

1. A method for rendering nonstick a mold made of a composite material intended for the manufacture of parts made of composite material, comprising the steps of:
(i) providing a mold made of composite material comprising an epoxy resin;
(ii) applying a powder of fluorinated polymer, having a minimum film-forming temperature lower than 300° C. and heat resistance at temperatures higher than 200° C., onto the walls of the mold to form a layer; and
(iii) heating the layer obtained to a temperature of between 260° C. and 300° C. to form a continuous film;
whereby a mold made of composite material is obtained, the walls of which are provided with a nonstick coating.

2. The method according to claim 1 wherein the mold made of composite material comprises carbon fibers.

3. The method according to claim 1, wherein the fluorinated polymer comprises a polymer or copolymer of fluoroalkylene.

4. The method according to claim 1, wherein the fluorinated polymer comprises a copolymer of fluoroethylene and fluoropropylene (FEP).

5. The method according to claim 4 wherein the powder of fluoroethylene and fluoropropylene copolymer (FEP) is applied in the form of an aqueous dispersion.

6. The method according to claim 1, wherein step (iii) is performed in an oven.

7. The method according to claim 1 wherein step (iii) is performed using infrared radiation.

8. The method according to claim 1, wherein the nonstick coating has a thickness of between 10 and 150 μm.

9. A mold in composite material obtained with the method according to claim 1.

10. The mold according to claim 9 intended for the manufacture of parts made of composite material.
